(19) United States
(12) Patent Application Publication
(10) Pub. No.: US 2002/0044070 A1
(43) Pub. Date: Apr. 18, 2002

(54) Method for determining and outputting travel instructions

(76) Inventor: Ralf Duckeck, Hildesheim (DE)

Correspondence Address: KENYON & KENYON, ONE BROADWAY, NEW YORK, NY, 10004, US

(21) Appl. No.: 09/900,673

(22) Filed: Jul. 6, 2001

(30) Foreign Application Priority Data
Jul. 6, 2000 (DE) 100 32 921.7-32

(51) Int. Cl. G08G 1/123

(52) U.S. Cl. 340/988; 340/990

(57) ABSTRACT

A method for determining and outputting travel instructions is proposed, which functions to make it possible to support a user through travel instructions, a sequence of travel instructions being determined by a central station, so that a data terminal of a user can be designed in a very simple manner.

### BACKGROUND INFORMATION

The present invention relates to a method for determining and outputting travel instructions according to the species of the main claim. A method and system for navigating a vehicle is already known from European Patent 715 289 A2, a vehicle being guided by an on-board navigational system, on the basis of an on-board digitized street map, along a travel route determined by a traffic guidance system. Planning data are transmitted from the vehicle to the external traffic computer, in accordance with which a complete travel route, determined by the traffic computer, is transmitted to the vehicle. By comparing the current position with the travel route on the basis of the digitized street map, the navigation is carried out in the vehicle by an on-board computer, which determines the appropriate travel instructions and which announces them over a loudspeaker and optically via a display. To be able to output current travel instructions, it is necessary in this context that the navigational device in the vehicle access a street map, which is either carried in the vehicle or is transmitted by the traffic guidance system. For the street map, a corresponding amount of storage space is required. Furthermore, the arithmetic unit must first determine the travel instructions for a driver from the transmitted route.

### ADVANTAGES OF THE INVENTION

In contrast, the method according to the present invention having the features of the main claim has the advantage that a sequence of travel instructions is transmitted from the central station, it only being necessary for an arithmetic unit in the vehicle to output the travel instructions in the corresponding sequence. As a result, it is possible to dispense with calculating the travel instructions in the vehicle as well as with carrying a digital street map, which has its high storage space requirements. In this context, it is particularly advantageous that current street links can be directly taken account of in the central station. For example, if the vehicle is moving in an area that is known to the user, no travel instructions are output but are requested only when necessary, preferably over the Internet, so that, on the one hand, the transmission costs for a user are minimal and, on the other hand, especially for travel outside the area that is known to the vehicle user, assistance is rendered the driver in the outputting of current travel instructions. It is also advantageous that the arithmetic unit can be designed solely for reproducing travel instructions and therefore in a very simple manner, i.e., having minimal working memory and low computing power, so that the arithmetic unit can be conceived as being very inexpensive.

It is also advantageous that the arithmetic unit be connected via the Internet to the central station, because as a result an inexpensive and rapid access to the central station is assured anywhere in the world, without necessitating high telephone costs, e.g., for telephone calls from abroad conducted on a cellular telephone.

It is also advantageous that the arithmetic unit is linked to the central station via a radio connection, so that a mobile use of the arithmetic unit is possible, e.g., in a vehicle.

It is also advantageous that, after a first retrieval, the sequence of travel instructions is stored in the central station for a specifiable period of time and is updated if necessary. As a result, it is possible to retrieve the already calculated route once again, e.g., using a different arithmetic unit. It is also advantageous to provide an arithmetic unit in a public operating console, so that travel instructions can be retrieved by the user even when the user himself is not carrying a device with which he can access the central station.

Furthermore, it is advantageous to determine a travel route via a first arithmetic unit located on a device that is especially suited for inputting, preferably a fixed personal computer, and to transmit it to a central station, from which the sequence of travel instructions can be retrieved thereafter, so that a device by which the sequence of travel instructions is retrieved is not required to have a device, or only a very simple one, for inputting a destination or for determining a travel route. In this context, it is particularly advantageous that a user can comfortably plan a travel route using his computer at home while taking account of personal preferences, interesting sights, and roads to be avoided, it being possible to input the preferences, interesting sights, and roads to be avoided very simply on his home PC, because, in contrast to a device in the vehicle, the usual input possibilities are available via keyboard and mouse.

It is also advantageous that a user enters into the arithmetic unit the reaching of a position, so that the arithmetic unit has the information concerning the point on the travel route at which a user is located. As a result, it is possible to dispense with a locator device. Furthermore, it is advantageous that if a user wishes to avoid these inputs, the arithmetic unit can be expanded such that it has connected to it a locator device which can determine the position of the arithmetic unit and which is offered, e.g., as a supplementary retrofit assembly kit for the arithmetic unit.

It is also advantageous that travel instructions are given for a driver of a vehicle and/or instructions are given for the use of public transportation. In this context, it is particularly advantageous that the central station, via the Internet, falls back on other service providers and, in this way, increases the information available to it.

It is also advantageous to arrange an arithmetic unit, which functions to carry out the method, in a car radio, so that no additional device is required to be disposed in the vehicle.

### DRAWING

Exemplary embodiments of the present invention are presented in the drawing and are discussed in greater detail in the description below.

FIG. 1 depicts a device for carrying out the method as recited in one of the preceding claims, having a central station, an arithmetic unit, and an Internet connection;

FIG. 2 depicts two method sequences, depicted in combination, for carrying out the method according to the present invention.

### DESCRIPTION OF THE EXEMPLARY EMBODIMENT

The method according to the present invention can be used by various traffic participants, e.g., pedestrians, bicyclists, users of buses and trains, as well as users of motor vehicles. In the case of users of motor vehicles, an arithmetic unit which is in contact with a central station, is preferably fixedly arranged in the motor vehicle. The other traffic participants have on board either a corresponding arithmetic unit or they use publicly accessible service devices having corresponding arithmetic units, using which the devices can be brought into contact with the central station. It is also possible that a user can remove the arithmetic unit from the vehicle and, e.g., continue to use it as a pedestrian. In what follows, an arithmetic unit arranged in a vehicle is described as an exemplary embodiment.

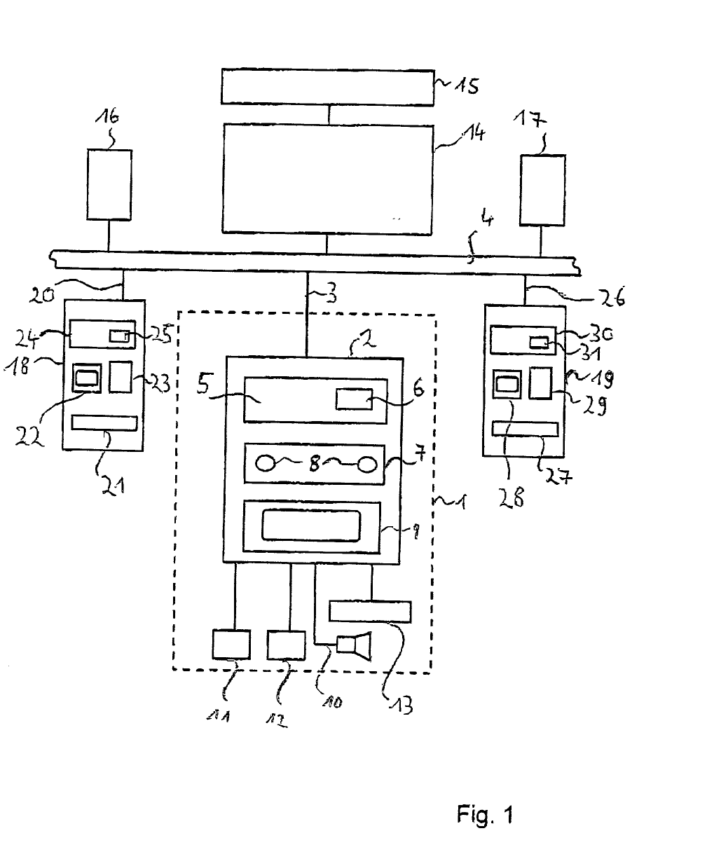

In FIG. 1, a car radio device 2 is depicted, which is arranged in a motor vehicle 1, which is depicted only symbolically by dotted lines. The car radio device is connected via a first data circuit 3 to a data network 4. Car radio device 2 has a first arithmetic unit 5 having a memory unit 6. The car radio device therefore also constitutes a first computing device. On car radio device 2, an operating and receiving unit 7 is represented as having operating elements 8 and receiving and amplifying devices that are not depicted in the Figure. In addition, car radio device 2 is provided with a display unit 9. Car radio device 2 is also connected to at least one loudspeaker 10. In one preferred embodiment, car radio device 2 is also connected to a GPS receiver 11, a dead reckoning locator device 12, and an input unit 13. Via first data circuit 3, a connection can be set up from car radio device 2 to a central station 14. Central station 14 is connected to a database 15. Central station 14 can also be connected to further service providers 16, 17, which are also connected to data network 4. In addition, a second computing device 18 and a third computing device 19 are connected to data network 4. Second computing device 18 is preferably executed as a personal computer, which is fixedly arranged, e.g., in a residence or at a workstation of a user. Second computing device 18 is connected via second data circuit 20 to data network 4. Second computing device 18 has an input unit 21, a display unit 22, a memory unit 23, and a second arithmetic unit 24, which has a working memory 25. Third computing device 19 is connected via a third data circuit 26 to data network 4. Third computing device 19 also has an input unit 27, a display unit 28, a memory unit 29, as well as a third arithmetic unit 30, and a working memory 31.

In one preferred exemplary embodiment, car radio device 2 is arranged in a central console of motor vehicle 1, so that it can be seen clearly and manipulated by a driver and by a passenger of the vehicle. In a first exemplary embodiment, a destination is entered into car radio device 2 via an input unit 13, which is also located within reach of the driver, and/or via operating elements 8. In addition, first arithmetic unit 5, by reverting to GPS receiver 11 (GPS=Global Positioning System), determines a geographical position of the vehicle. If a satellite connection is impossible, then it is possible to determine the position using dead reckoning locator device 12. In a further exemplary embodiment, a GPS receiver 11 or a dead reckoning locator device 12 is not connected to car radio device 2, and a starting position is also input into car radio device 2 via input unit 13 or via operating elements 8.

First arithmetic unit 5 via first data circuit 3, establishes a connection to data network 4. Data network 4 is preferably the Internet. First data circuit 3, in this context, is achieved preferably via a mobile radiocommunications interface arranged in motor vehicle 1 and not depicted in FIG. 1, the mobile radiocommmunications interface establishing via mobile radio telephony a connection to an Internet provider, through which in turn a connection to the Internet is set up. For an advantageous Internet connection, the car radio device is provided with an operating system for a small computer, which makes it possible to access, e.g., the World Wide Web (WWW) using a suitable data protocol. In one preferred exemplary embodiment, car radio device 2 using the WAP (Wireless Application Protocol) accesses the Internet. The mobile radiocommunications interface is preferably executed as a GSM- or as a UMTS-interface (UMTS Universal Mobile Telecommunications System). The Internet address of central station 14 is preferably stored in memory unit 6 of first arithmetic unit 5. Via first data circuit 3, the starting point and the destination are communicated to central station 14. Central station 14, in this context, by reverting to database 15, determines the speediest and/or shortest route from the starting point to the destination. Database 15 has a data carrier having a digitized street map of a street and route network. In one preferred exemplary embodiment, central station 14, in this context, falls back on further service providers 16, 17, which are also connected to data network 4. These service providers are, e.g., providers of traffic and road condition information or of schedules, e.g., of ferries, trains, and/or airlines. In addition, further service providers 16, 17 can also be Internet providers for the route search, transmitting appropriate travel routes to central station 14. From the travel route determined by central station 14, central station 14 determines a sequence of travel instructions. The sequence of travel instructions is transmitted from central station 14 via data network 4, and over first data circuit 3, back to car radio device 2. In one preferred exemplary embodiment, it is possible that an identification of a user takes place with respect to the central station by inputting a code using input unit 13 and by transmitting the code via first data circuit 3. In this manner, the retrieval of a sequence of travel instructions can be charged to a user, e.g., by debiting an account or by charging a credit card. The received sequence of travel instructions is stored in memory unit 6 by first arithmetic unit 5. Subsequently, the travel instructions are output by car radio device 2 via display unit 9 and/or via loudspeaker 10. A first travel instruction is displayed, e.g., in display unit 9, for example, “at Stuttgart intersection, switch to A 831.” If it is now determined by the GPS receiver that the Stuttgart intersection has been reached, then the next travel instruction is output, thus, e.g., “leave the autobahn at Vaihingen.” For this purpose, a geographical position is assigned to the travel instructions, the position being transmitted to the arithmetic unit along with the travel instruction. If the Vaihingen exit is reached, then the next travel instruction is output. Further outputs of travel instructions follow until the destination is reached. In one further exemplary embodiment, a user can also communicate to car radio device 2, through an appropriate manipulation of the operating elements 8, that the displayed position, e.g., the Stuttgart intersection, has been reached. A dead reckoning locator device 12 or a GPS receiver 11 is not necessary in this exemplary embodiment. While the method is being carried out, if no travel instructions are being output, it is possible via the receiving device of car radio device 2 to output received music over loudspeaker 10. Display unit 9 is executed in one preferred exemplary embodiment as a liquid crystal display, preferably as a dot-matrix display, using which, in one preferred exemplary embodiment, it is possible to output at least text information and simple graphics, so that an inexpensive display can be used as display unit 9.

In place of car radio device 2 arranged in the motor vehicle 1, second computing device 18 can be connected to data network 4, route planning, in one preferred exemplary embodiment, being carried out by a user through second computing device 18. Via input unit 21, a user inputs the start and destination into second arithmetic unit 24, which by reverting to memory unit 23 displays a desired route in display unit 22, a route which a user can in turn select via input unit 21.

In a first exemplary embodiment, the travel route determined in this manner is transmitted to central station 14 in the same way via second data circuit 20, on which the starting and destination points determined by car radio device 2 are also transmitted to central station 14. In a further exemplary embodiment, a travel route is already determined by second arithmetic unit 24 through accessing memory unit 23, e.g., a data carrier having a stored digital street map, and a sequence of travel instructions is generated from the travel route. Via second data circuit 20, this sequence of travel instructions is transmitted to central station 14, where the sequence of travel instructions is stored. This sequence of travel instructions can subsequently be retrieved by a user from car radio device 2, so that for a user a data transmission takes place from second computing device 18 via central station 14 to car radio device 2 and memory unit 6 of first arithmetic unit 5. In one preferred exemplary embodiment, a user identifies himself through inputting, using input unit 13, a code previously established by him, the input code being transmitted from first arithmetic unit 5 to central station 14. In a further exemplary embodiment, it is possible for the travel instructions stored in the central station to be modified as a function of current information from the central station and for the modified travel instructions to be transmitted to car radio device 2.

In a further exemplary embodiment, it is possible to access central station 14 from a third computing device 19 over a third data circuit 26, using data network 4. Third computing device 19 is executed as a public operating device, which is arranged, e.g., in railway stations, airports, or in downtown areas, so that from the aforementioned locations a user can access central station 14 and can also retrieve his travel route, previously transmitted to central station 14 using second computing device 18, in the form of sequences of travel instructions, or so that he can directly retrieve the travel instructions transmitted to central station 14. In this context, it is not necessary that a user himself have his own device on board. In one preferred exemplary embodiment, the third arithmetic unit is also provided with a memory unit 29, in which a street map is stored, so that in the preferred exemplary embodiment a user can also determine a travel route using the third arithmetic unit and can transmit a sequence of travel instructions to central station 14. This is especially advantageous when travel instructions are desired for the use of public transportation. Because it is possible that one travel route is retrieved by a user from different arithmetic units, the sequence of travel instructions remains stored in central station 14 for a preestablished period of time, e.g., two days, so that a user can retrieve the travel route from a plurality of arithmetic units, e.g., from car radio device 2, or from a public computing device, in the form of third computing device 19.

Travel instructions for a car driver are generally information for the automobile driver concerning locations at which he should turn off from a street in a given direction. In addition, the travel instructions can also support a car driver by confirming to the driver that he is still following the correct route. With respect to using public transportation, travel instructions are information concerning which train and/or bus or which airplane should be selected at a given point in time from a given location.

In a further exemplary embodiment, car radio device 2 can be removed from motor vehicle 1, thus also providing theft protection for car radio device 2. Using a self-sufficient voltage source in car radio device 2, not depicted in FIG. 1, it is also possible to request travel instructions from central station 14 outside motor vehicle 1, e.g., for public transportation.

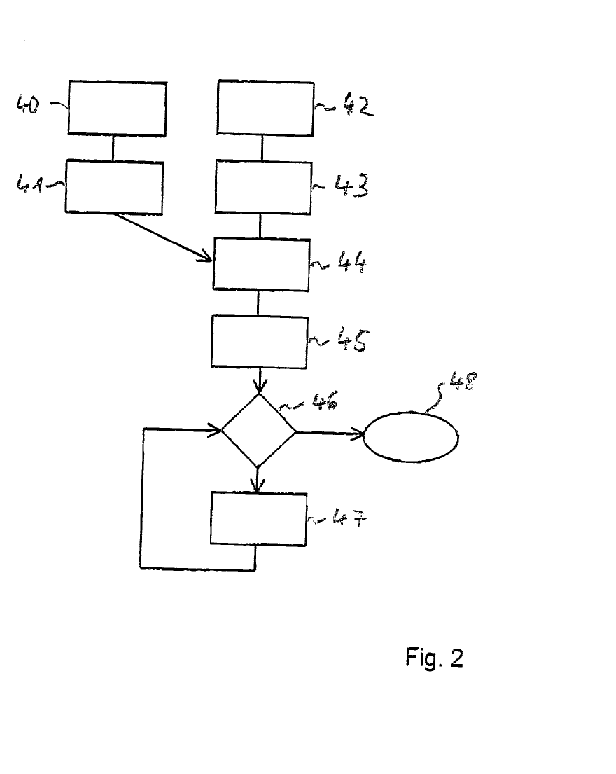

In FIG. 2, a method according to the present invention is depicted, having two different starting positions of the method. In a first exemplary embodiment, a travel route and a sequence of travel instructions are first determined in an inquiry step 40 using second computing device 18. In a subsequent transmission step 41, the determined sequence of travel instructions is transmitted via data network 4, preferably the Internet, to central station 14. In a further exemplary embodiment, a method sequence according to the present invention begins with an input-transmission step 42, in which a starting point and destination are input into car radio device 2 and are transmitted from the first arithmetic unit to central station 14. In a subsequent determination step 43, from the starting point and the destination, the shortest and/or speediest travel route is determined between the starting point and the destination, and from this a sequence of travel instructions is generated and stored by central station 14 for a driver of the vehicle. A retrieval step 44 follows both determination step 43 as well as transmission step 41, the method after retrieval step 44 proceeding in the same way for both of the method beginnings according to the present invention indicated above. In retrieval step 44, the sequence of travel instructions is requested via data network 4 by central station 14. An identification of the user preferably takes place in this context. In a further exemplary embodiment, it is possible, if starting point and destination have been transmitted to central station 14, to dispense with a retrieval step, by automatically starting a transmission of a sequence of travel instructions by central station 14 as soon as central station 14 has calculated the sequence of travel instructions. In a subsequent transmission step 45, the stored sequence of travel instructions is transmitted from central station 14 to car radio device 2 and is stored in memory unit 6. In a subsequent check step 46, a check test is carried out by first arithmetic unit 5 as to whether the end of the sequence of travel instructions has been reached. If this is not the case, then a branching occurs to an output 47 of the next travel instruction. If output 47 was not previously reached, then the first travel instruction of the sequence of travel instructions is output. When output 47 is reached, the travel instruction pending for outputting is acoustically output once over loudspeaker 10, preferably in the form of speech. In display unit 9, the travel instruction is displayed until a user has indicated, via operating elements 8, that he has reached the position indicated in the travel instruction or until the fact of reaching or going beyond the corresponding position has been established by GPS receiver 11 or dead reckoning locator device 12. For this purpose, position data are preferably assigned to the travel instruction, making it possible for first arithmetic unit 5 to carry out a comparison between the position assigned to the travel instruction and the position determined by GPS receiver 11 or dead reckoning locator device 12. If it is determined by first arithmetic unit 5 that the position has been reached, then a branching occurs back to check step 46. If in check step 46 it is determined that no further travel instruction is present, then a branching occurs to an end step 48, in which the method according to the present invention is ended. In this context, display unit 9 displays, e.g., the text “destination reached.”

What is claimed is:

1. A method for determining and outputting travel instructions for a travel route from a starting point to a destination, an arithmetic unit being connected at least temporarily with a central station, the starting point and destination being transmitted to the central station, the travel route being determined by the central station,
wherein a sequence of travel instructions is determined by the central station from the travel route and the sequence of travel instructions is transmitted from the central station to the arithmetic unit, the sequence of travel instructions is stored in the arithmetic unit, and the travel instructions are output by the arithmetic unit, one after the other, in accordance with the sequence of travel instructions.

2. The method as recited in claim 1,
wherein the arithmetic unit is connected to the central station via the Internet.

3. The method as recited in one of the preceding claims,
wherein the central station is linked via a radio connection to an arithmetic unit arranged in a mobile computing device.

4. The method as recited in one of the preceding claims,
wherein, after a first retrieval, the sequence of travel instructions continues to be stored in the central station for a specifiable period of time, and the stored sequence of travel instructions is updated during this period of time.

5. The method as recited in one of the preceding claims,
wherein the travel instructions are retrieved by an arithmetic unit using a publicly accessible operating device.

6. The method as recited in one of the preceding claims,
wherein the travel route is planned by a fixed second arithmetic unit arranged preferably in a personal computer, a sequence of travel instructions relating to the travel route is transmitted to a central station, and the sequence of travel instructions is retrieved by the first arithmetic unit from the central station.

7. The method as recited in one of the preceding claims,
wherein positions on the travel route are assigned to the travel instructions, the fact of reaching a position is input into the arithmetic unit by a user, and the travel instructions are output as a function of the positions that are input.

8. The method as recited in one of the preceding claims,
wherein a locator device is connected to the arithmetic unit, a position of the arithmetic unit is determined using the locator device, and a travel instruction from the sequence of travel instructions is output as a function of the position of the arithmetic unit.

9. The method as recited in one of the preceding claims,
wherein provision is made in the travel instructions for travel instructions for a driver of a vehicle and/or instructions for the use of public transportation.

10. The method as recited in one of the preceding claims,
wherein the central station is connected via a data network, preferably the Internet, to further service providers, and the sequence of travel instructions is generated through access to other service providers.

11. An arithmetic unit for carrying out the method as recited in one of the preceding claims.

12. The arithmetic unit as recited in claim 11,
wherein the arithmetic unit is arranged in a car radio device.

13. A central station for carrying out the method as recited in one of claims 1-10.
